(19) United States
(12) Patent Application Publication
(10) Pub. No.: US 2020/0134573 A1
(43) Pub. Date: Apr. 30, 2020

(54) SYSTEM FOR IDENTIFYING DAMAGED BUILDINGS

(71) Applicant: Alexander Vickers, Addison, TX (US)

(72) Inventor: Alexander Vickers, Addison, TX (US)

(21) Appl. No.: 16/176,858

(22) Filed: Oct. 31, 2018

(51) Int. Cl. G06Q 10/00; G06T 7/00; G06Q 50/08; G06Q 30/02; G06F 17/30; G06F 15/18

(52) U.S. Cl. CPC G06Q 10/20; G06T 7/001; G06Q 50/08; G06Q 30/0205; G06T 2207/20081; G06F 17/30241; G06F 15/18; G06T 2207/10032; G06Q 30/0283

(57) ABSTRACT

A system for identifying buildings that are damaged in a geographic area from a damaging weather event. Accessing weather data and identifying a date of the damaging weather event. Accessing geographic data for identifying the geographic area where the damaging weather event occurred. Accessing visual data of buildings where the damaging weather event occurred. Identifying an individual building that was damaged based on the visual data, geographic data and weather data.

### BACKGROUND

### Technical Field

The disclosed principles relates generally to automated systems and methods for identifying roof damages. More specifically, the disclosed principles relate to automated systems and methods for use by roofing service providers to identify the serviceable roofs with damages in a desired geographical area.

### Description of the Related Art

Building roofs may get damaged due to various factors, such as, but not limited to, hail events, storms, other weather conditions, long service life, etc. The owners of the buildings need to know if their building was one of those that were actually damaged so that repairs may be made on time and to claim the roofing insurance from the insurance provider. Roofing services providers can utilize this opportunity by identifying the damaged or serviceable roofs in a selected geographical area to sell their roofing services and associated products to perform the replacement or maintenance of the damaged roofs. Thus, identification of the serviceable roofs with damages in a desired area is beneficial for the roofing services providers to increase their sales. There are several prior arts that teach us the identification of roofing features from images of the roofs captured using drones and other aerial image capturing methods. The roofing features identified from the images of the roofs is beneficial for roofing services providers to specify materials and associated costs for both newly-constructed buildings, as well as for replacing and upgrading existing structures. Various software systems have been implemented to process aerial images to identify roofing characteristics of many roofing structures. However, such systems are often time-consuming and difficult to use, and require a great deal of manual input by a user. Further, such systems may not have the ability to improve results through continued usage over time. The following prior arts are hereby incorporated by reference for their supportive teachings of the disclosed principles:

U.S. Pat. No. 8,731,234 titled “Automated Roof Identification Systems And Methods” issued to EagleView Technologies Inc. discloses an automatic roof identification systems and methods. The patent discloses a roof estimation system configured to automatically detect a roof in a target image of a building having a roof. Automatically detecting a roof in a target image includes training one or more artificial intelligence systems to identify likely roof sections of an image. The artificial intelligence systems are trained on historical image data or an operator-specified region of interest within the target image. Then, a likely outline of the roof in the target image can be determined based on the trained artificial intelligence systems. The likely roof outline is used to generate a roof estimate report.

U.S. Pat. No. 9,262,564 titled “Method Of Estimating Damage To A Roof” issued to State Farm Mutual Automobile Insurance Co. discloses a system and a method for estimating damage to a roof. The method includes the steps of generating, from a first point cloud representing a roof, a second point cloud representing a shingle. The system and method further includes comparing the second point cloud to a model point cloud, the model point cloud representing a model shingle. The method also includes identifying, based on the comparison, a first set of points, correlating each point within the first set of points to a representation of a point of damage. The system and method includes identifying a second set of points, the second set of points including at least one point from the first set, correlating the second set of points to a representation of a damaged region of the roof. Further, the method includes generating and storing to a memory a report based on the second set of points for subsequent retrieval and use in estimating damage to at least part of the roof. A damage assessment module operating on a computer system automatically evaluates a roof, estimating damage to the roof by analyzing a point cloud of a roof. The damage assessment module identifies individual shingles from the point cloud and detects potentially damaged areas on each of the shingles. The damage assessment module then maps the potentially damaged areas of each shingle back to the point cloud to determine which areas of the roof are damaged. Based on the estimation, the damage assessment module generates a report on the roof damage.

Another prior art, U.S. Pat. No. 9,613,538 titled “Unmanned Aerial Vehicle Rooftop Inspection System” issued to Unmanned Innovation Inc. discloses methods, systems, and apparatus, including computer programs encoded on computer storage media, for an unmanned aerial system inspection system. One of the methods is performed by a unmanned aerial vehicle (UAV) and includes receiving, by the UAV, flight information describing a job to perform an inspection of a rooftop. The UAV ascends to a particular altitude and an inspection of the rooftop is performed including obtaining sensor information describing the rooftop. Location information identifying a damaged area of the rooftop is also received. An inspection of the damaged area of the rooftop is performed including obtaining detailed sensor information describing the damaged area. The invention utilizes the UAV to schedule inspection jobs and to perform inspections of potentially damaged properties, e.g., a home, an apartment, an office building, a retail establishment, etc. By intelligently scheduling jobs, a large area can be inspected using UAV(s), which reduces the overall time of inspection, and enables property to be maintained in safer conditions. Furthermore, by enabling an operator to intelligently define a safe flight plan of a UAV, and enable the UAV to follow the flight plan and intelligently react to contingencies, the risk of harm to the UAV or damage to surrounding people and property can be greatly reduced.

### SUMMARY

The disclosed principles relates to a system for identifying buildings that are damaged in a geographic area from a damaging weather event; and more particularly to a system for assisting one or more roofing services providers to sell a variety of roof repairing services and products to a number of relevant customers. All the above incorporated systems and methods can be utilized to identify the damages to the buildings and roofs by random inspection of the buildings and roofs at any particular date or a selected time. However, such methods cannot be utilized to identify the serviceable roofs with damages caused by severe weather activities such as a hailstorm over a large selected geographical area using weather information and data bases. Moreover, the above systems and methods cannot be utilized by the roofing services providers to identify the roof characteristics of a multiple number of roofs of buildings spread over a wide geographical area using weather data. Hence, there exists a need for an automated system and method for assisting the roofing services providers to identify the serviceable roofs with damages caused by severe weather activities such as a hailstorm over one or more geographical areas using weather historical data. Moreover, the needed system and method would provide location information of the identified serviceable roofs with damages to enable the roofing services providers to sell roof repairing services and products to the relevant customers. Furthermore, the needed system and method would also assist the owners of the building to claim the existing roofing insurance from their insurance providers on time to perform maintenance on the damaged roofs.

The present systems in accordance with the disclosed principles for assisting the roofing services providers to sell roof repairing services and products to the relevant customers with one or more serviceable roofs includes an electronic computing device having a memory unit configured to store a number of instructions of an application for identifying the serviceable roofs in a selected geographical area. The instructions of the application stored in the memory unit includes a number of artificial intelligence (AI)-based image processing instructions, which are executable using a processor associated with the electronic computing device. The roofing services provider can launch the application from the electronic computing device to execute the artificial intelligence-based image processing instructions of the application, and to perform a number of tasks including capturing a number of images of the roofs in a selected geographical area. The images of the roofs are obtained from a series of time-lapse images, which are captured from a number of past and real-time satellite images of the geographical area, captured over a preset period of time. As used herein, any reference to images or imaging includes any and all imaging technologies, and any images resulting therefrom, using any type of imaging technology either now existing or later developed. The artificial intelligence-based instructions of the application processes the images of the roofs to identify a number of roof characteristics associated with each of the roofs. The roof characteristics are identified by comparing a number of features associated with each of the roofs, identified from the series of time-lapse images of the roofs, with a number of predefined roof features associated with a number of roof types stored in a dynamically updated database associated with the present application.

Further, the present application receives the weather data of the geographical area over the preset period of time from one or more weather data service providers. The weather data may include a variety of weather activities such as hailstorm activities capable of damaging the different roofs under analysis. Each of the roofs from the images are converted through a number of image conversion steps including an image pixilation step to identify one or more damages on the roofs caused by the severe weather activity in the selected geographical area. The present application identifies the serviceable roofs with damages by analyzing a number of sequential changes in respective pixels of the series of time-lapse images and correlating with the roof characteristics and the weather activities during the series of time-lapse images capable of damaging the particular roof type. Once the present system identifies the serviceable roofs with damages, the location information associated with a property having the serviceable roof is obtained from the past and real-time satellite images. This roofing services provider utilizes this information to locate the respective buildings and present the information to the owners of the buildings to assist them in getting the roofing services claims to perform the relevant roof maintenance. This in turn improves the sales and services of the roofing services provider.

The disclosed principles also relate to a computer-implemented method for assisting the roofing services providers to sell their roof repairing services and products to relevant customers. The method includes the steps of providing the roofing service provider with an application configured to run on an electronic computing device for identifying the serviceable roofs in a geographical area. The roofing service provider can launch the application using the electronic computing device to capture the aerial images of the roofs in the geographical area. The roofing service provider can further select a desired time period for capturing the images of the roofs in the geographical area. The images of the roofs form a series of time-lapse images, obtained from the past and real-time satellite images of the geographical area, captured over the desired time period set by the roofing services provider. Now the artificial intelligence-based instructions of the application analyses the roofs in the images and identifies the roof characteristics of the each of the roofs in the image. The application also receives the weather data including the weather activities, during the preset time period, capable of damaging roof types present in the image. This helps the roofing services providers to identify the roofs, which are at high risk of failure or getting damaged due to the severe weather activity during the present period. The application identifies the damages on the roofs, mainly caused by the weather activities, by automated conversion of the series of time-lapse images through a number of image conversion steps including an image pixilation step. The application identifies the serviceable roofs with damages by analyzing a number of sequential changes in respective pixels of the series of time-lapse images and correlating with the roof characteristics and the weather activities during the series of time-lapse images capable of damaging the particular roof type. Once the serviceable roofs with damages are identified, the location information associated with that property is identified, which is further utilized by the roofing services provider to contact the owners of the buildings to assist them in getting the roofing services claims and to perform the relevant roof maintenance on the damaged roof.

Other features of the disclosed principles are discussed below. The disclosed principles are designed to fulfill the below and other additional features as detailed in the following claims section and detailed description section of the present disclosure.

One feature of the disclosed principles provides artificial intelligence-based systems for assisting the roofing services providers to identify the serviceable roofs with damages in a selected geographical area.

Another feature of the disclosed principles provides an electronic computing device running an application for identifying the serviceable roofs with damages in a selected geographical area from past and real-time satellite images of the geographical area.

Another feature of the disclosed principles provides an electronic computing device running an application for identifying roof characteristics including roof type, material, age and other relevant information associated with a number of roofs present in a selected geographical area.

Another feature of the disclosed principles provides an electronic computing device running an artificial intelligence-based self-learning application for identifying the serviceable roofs with damages in a selected geographical area.

Another feature of the disclosed principles provides an provides an electronic computing device running an artificial intelligence-based application for identifying the damages on the roofs caused by severe weather activities in the geographical area.

Another feature of the disclosed principles provides electronic computing device running an artificial intelligence-based application for predicting the serviceable roofs in a geographical area and a number of roofing maintenance related information associated with the serviceable roofs.

Another feature of the disclosed principles provides a system having an electronic computing device running an artificial intelligence-based application for transforming the images of the roofs through a series of steps including image pixilation to identify the serviceable roofs with damages in a geographical area.

Another feature of the disclosed principles provides an artificial intelligence-based application with a dynamic graphical user interface for allowing the roofing services providers to manually analyze the serviceable roofs with damages in a geographical area.

Another feature of the disclosed principles provides a method for assisting the roofing series providers to identify the location information of the serviceable roofs with damages within a geographical area for selling their roofing products and services.

Another feature of the disclosed principles provides a method for alerting the roofing services providers to identify the location information of the serviceable roofs with damages within a geographical area and assisting them to contact the owners of the buildings within a specific time period for availing the roofing insurance claims.

Another feature is to provide a system for identifying buildings that are damaged in a geographic area from a damaging weather event, comprising: a) accessing weather data and identifying a date of the damaging weather event; b) accessing geographic data for identifying the geographic area where the damaging weather event occurred; c) accessing visual data of buildings where the damaging weather event occurred; and d) identifying an individual building that was damaged based on the visual data, geographic data and weather data. Wherein the visual data involves visual images of roofs of buildings. Wherein the damaging weather event is caused by hail striking the buildings. Wherein a global mapping service provides the visual data and geographic data. Wherein the weather data is at least in part derived from NOAA (national oceanic and atmospheric administration) collected data. Wherein, accessing the visual data of the buildings that were in the damaging weather event is examined before and after the date of the damaging weather event.

These, together with other features of the disclosed principles, along with the various features of novelty, which characterize the disclosed principles, are pointed out with particularity in the disclosure. For a better understanding of the disclosed principles, its operating advantages and the specific objects attained by its uses, reference should be had to the accompanying drawings and descriptive matter in which there are illustrated exemplary embodiments of the systems and methods according to the disclosed principles. In this respect, before explaining at least one embodiment of the disclosed principles in detail, it is to be understood that the disclosed principles are not limited in its application to the details of construction and to the arrangements of the components set forth in the following description or illustrated in the drawings. The disclosed principles are capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

To further clarify various aspects of some example embodiments of the disclosed principles, a more particular description of the disclosed principles will be rendered by reference to specific embodiments thereof that are illustrated in the appended drawing. It is appreciated that the drawing depicts only illustrated embodiments of the disclosed principles and are therefore not to be considered limiting of its scope. Elements in the figures have not necessarily been drawn to scale in order to enhance their clarity and improve understanding of these various elements and embodiments of the disclosed principles. Furthermore, elements that are known to be common and well understood to those in the industry may not be depicted in order to provide a clear view of the various embodiments of the disclosed principles, thus the drawings are generalized in form in the interest of clarity and conciseness. The disclosed principles will be described and explained with additional specificity and detail through the use of the accompanying drawing in which: FIG. 1 illustrates a schematic diagram of a system for assisting a roofing services provider to sell a variety of roof repairing services and products to a number of customers, according to one embodiment of the disclosed principles;

FIG. 2 illustrates a block diagram showing a number of hardware and software components of the electronic computing device configured to run an application for identifying a number of serviceable roofs in a geographical area, according to an embodiment of the disclosed principles;

FIG. 3 illustrates a flowchart showing a number of operating steps of the present application for assisting a roofing services provider to sell a number of roof repairing services and products to a number of customers, according to an embodiment of the disclosed principles;

FIG. 4 is a screenshot image of chart showing the details of the hailstorm activities over a particular area and the hail stone sizes fell during the particular hailstorm activity, according to an exemplary embodiment of the disclosed principles;

FIG. 5 is an exemplary image of the roofs obtained from the series of time-lapse images captured from the past and present satellite images of the selected geographical area(s), according to an exemplary embodiment of the disclosed principles;

FIG. 6 is an exemplary flowchart showing the image processing steps for detecting the roof characteristics and damages on the roofs, according to one or more embodiments of the disclosed principles;

FIG. 7 is an exemplary image of the roofs obtained from the series of time-lapse images captured from the past and present satellite images of the selected geographical area(s), according to an exemplary embodiment of the disclosed principles;

FIGS. 8, 9 and 10 show exemplary images of a roof obtained from satellite images of the selected geographical area(s) taken over a period of time, according to an exemplary embodiment of the disclosed principles; and

FIG. 11 is a flowchart showing the steps of the present method for assisting the roofing services providers to sell a variety of roof repairing services and products to the customers, according to an exemplary embodiment of the disclosed principles.

### DETAILED DESCRIPTION

In the following discussion that addresses a number of embodiments and applications of the disclosed principles, reference is made to the accompanying drawings that form a part hereof, and in which is shown by way of illustration specific embodiments in which the disclosed principles may be practiced. It is to be understood that other embodiments may be utilized and changes may be made without departing from the scope of the disclosed principles. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Further, various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiments of the disclosed principles and together with the description, serve to explain the disclosed principles. To the accomplishment of the foregoing and related ends, certain illustrative aspects of the disclosed principles are described herein in connection with the following description and the annexed drawings. These aspects are indicative, however, of but a few of the various ways in which the disclosed principles can be employed and are intended to include all such aspects and their equivalents. Other advantages and novel features of the disclosed principles will become apparent from the following detailed description of the disclosed principles when considered in conjunction with the drawings.

Further, the following section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The disclosed principles relate to systems and methods for assisting one or more roofing services providers to find one or more buildings having a number of serviceable roofs within a particular geographical area. The identification of the buildings with the serviceable roofs enables the roofing service providers to contact the owners or the building or to find potential customers to sell a variety of roof repairing services and products to the customers. Further, the disclosed systems and methods enable the roofing services providers to send their sales personnel to visit the buildings with the serviceable roofs and visually present the images of the damages on the roofs for performing the much-needed maintenance of the roof of the building. In some cases, the harsh weather activities such as the hailstorm, wind, rain and other weather activities damage the roofs or a part of the roofs of the buildings. The present systems and methods enable the identification of the damages to the roofs after each of these weather activities and presents the damage related information to the customers for performing the needed roof maintenance on time. In some instances, the present systems and methods enable the customers or owners of the buildings with serviceable roofs to request for roof insurance claims based on the severity of damages on the roofs caused by the harsh weather activities such as, but not limited to, the hailstorm with large size hail stones capable of damaging the roofs. Thus, the present systems and methods enable the customers or owners of the buildings to properly maintain the building roofs to improve safety, life span and reduce the overall maintenance and replacement cost of the roof of the building. Further, the present systems and methods improve the sales and profitability of the roofing services providers and assists to provide better service to the customers.

Referring now to FIG. 1, there is illustrated a schematic diagram of a system 100 for assisting a roofing services provider to sell a variety of roof repairing services and products to a number of customers, according to an exemplary embodiment of the disclosed principles. The present system 100 for assisting the roofing services providers to identify a number of serviceable roofs in a particular geographical area and sell the roof repairing services and products to the relevant customers includes an electronic computing device 102 configured to run an application 120 for identifying the serviceable roofs in one or more selected geographical area, according to an exemplary embodiment of the disclosed principles. In an exemplary embodiment of the present system 100, the electronic computing device 102 is a computer having a memory unit to store a number of instructions of the application 120 for identifying the serviceable roofs in the selected geographical area and a processor to execute the instructions of the application 120 to perform a variety of image processing, data comparison and correlation steps to identify the serviceable roofs with one or more damages on the roofs present in the selected geographical area. In some other embodiments, the electronic computing device 102 is a remote server having a memory unit to store the instructions of the present application 120 for identifying the serviceable roofs and also includes one or more processors to process the instructions of the application 120 perform a variety of image processing, data comparison and correlation steps to identify the serviceable roofs with one or more damages within the selected geographical area. Further, in an exemplary embodiment of the disclosed principles, the instructions of the application 120 includes a number of artificial intelligence-based instructions, which when executed using the processor identifies the serviceable roofs with one or more damages within the selected geographical area and also automatically improves the image processing, data comparison and correlation steps employed to identify the serviceable roofs with the damages.

The instructions of the present application 120 for identifying the serviceable roofs with damages, when executed using the processor, performs a number of automated tasks such as, but not limited to, capturing one or more images of the roofs of the buildings in the geographical area. In an exemplary embodiment of the disclosed principles, the images of the roofs of the buildings in a desired geographical area is obtained from one or more aerial images covering the geographical area. In some instances, the images captured using the present application 120 includes a series of aerial images of the geographical area obtained from one or more satellite images captured using one or more satellites 200 covering the particular geographical area 206. In some other instances, the present application 120 captures the images in form of a series of time-lapse images from a series of past and real-time satellite images, captured over a period of time, covering the geographical area. As used herein, such images or image-capturing technology may encompass any and all imaging technologies, and any images resulting therefrom, using any type of imaging technology either now existing or later developed. Examples of such imaging technology may include infrared imaging, ultra-violet imaging, thermal imaging, or any one of a variety of multi spectral imaging technologies.

In some embodiments, the present application 120 running on the electronic computing device 102 allows a user to set a desired time period and one or more geographical areas to receive the satellite images covering the geographical area(s) captured within the desired time period. The application 120 processes the received satellite images to generate the series of time-lapse images, which are further processed using the artificial intelligence-based instructions of the application 120 to identify the serviceable roofs in the particular geographical area(s) with one or more damages caused by severe weather activates or other causes that occurred in the geographical area within the time period of capturing the satellite images. In some instances, the satellite images covering the geographical area(s), captured within the desired period of time, are obtained from an aerial image capturing application launched from the electronic computing device 102. In some other instances, the present application 120 for identifying the serviceable roofs having one or more damages, within the selected geographical area(s), communicates directly with the aerial image capturing application launched from the electronic computing device 102 to generate the series of time-lapse images covering the roofs of the buildings in the selected geographical area(s). In some other instances, the aerial image capturing application launched from the electronic computing device 102 communicates with a remote satellite image data server 202 to retrieve the satellite images of the geographical area(s) captured within the selected period of time.

The instructions of the present application 120 for identifying the serviceable roofs, when executed using the processor of the electronic computing device 102, enables automated processing of the images of the roofs in the selected geographical area, which is made available in form of the series of time-lapse images from the past and real-time satellite images of the selected geographical area, to identify a variety of roof characteristics associated with each of the roofs in the images. In one or more embodiments of the disclosed principles, the roof characteristics identified by processing the images of the roofs includes a roof type, an age of the roof, at least one roof material, at least one roof dimension, at least one roof maintenance related information, at least one pre-existing roof damage related information, at least one material covering the roof, and other related roof information. In some instances, execution of the instructions of the application 120 using the processor of the electronic computing device identifies the roof characteristics of each of the roofs in the images. The application 120 identifies the roof characteristics by comparing a variety of features of the roofs identified from the series of time-lapse images of the roofs, using the artificial intelligence-based instructions of the application 120, to a number of predefined roof features associated with different roof types stored in the dynamically updated database associated with the present application 120.

The instructions of the present application 120 for identifying the serviceable roofs, when executed using the processor of the electronic computing device 102 further enables the automated retrieval of the weather data of the geographical area over the preset period of time. In some instances, the application 120 retrieves the weather data associated with the geographical area during the preset period of time from a weather data service provider. In some other instances, the application 120 retrieves the weather data associated with the geographical area during the preset period of time from a remote weather data server 204 from the weather data service provider. The instructions of the application 120, when executed using the processor associated with the electronic computing device 102, enables the automated identification of one or more weather activities in the selected geographic area, within the selected period of time, capable of damaging one or more roofs in the particular geographic area. In some instances, the weather activates capable of damaging the roofs in the particular geographic area include hailstorm activities with varying hail stone sizes rated for damaging the different types of roofs. In some instances, the artificial intelligence-based instructions of the present application 120 predicts the roofs in the particular geographical area with high chances of getting damaged after the severe weather activities such as the hailstorm activities with hail stone sizes capable of damaging the roofs. The artificial intelligence-based instructions of the present application 120 further analyzes the series of time-lapse images of the roofs before and after the severe weather activities to identify the changes in the roof characteristics associated with the roofs in the geographical area. Further, the instructions of the present application 120 for identifying the serviceable roofs, when executed using the processor of the electronic computing device 102 enables the conversion and analysis of the series of time-lapse images of the roofs through a number of image conversion steps including an image pixilation step to automatically identify one or more damages on the roofs. In some instances, the serviceable roofs within the selected geographical area with one or more damages are identified by analyzing the sequential changes in the pixels of the series of time-lapse images. These sequential changes in the pixelated images are then correlated with the roof characteristics such as the type of roof, material, age of the roof, etc., and the presence of weather activities such as hailstorm activities during or prior to the duration of the sequential changes in the pixels of the series of time-lapse images to identify the presence of any damages on the roofs. Thus, the present application 120 allows the roofing services providers to identify the serviceable roofs in the particular geographical area to sell their services and products to the right customers. Moreover, the present application 120 allows the roofing services providers to identify location information associated with each of the serviceable roofs for making direct contact with the owner of the property. Furthermore, the present application 120 allows the roofing services providers to identify the exact location of serviceable roofs in the particular geographical area, identify the roof characteristics such as the type of roof, type of roofing material, age of roof, prior maintenance activities performed on the roof, etc., and the damages to the roof, beforehand and preset the data in form of images to the owner of the buildings for easily convicting them to perform the maintenance activities on the roof. In some instances, the present application 120 allows the roofing service providers to identify the cause of the damage to the serviceable roofs, such as the weather activities including large hail stones associated with the hailstorm activities, identified in the particular geographical area and the important dates of the weather activities for assisting the building owners to contact their roofing insurance company with the provided information. The building owners can contact their roofing insurance service providers with the data provided by the roofing services provider to make an insurance claim for performing maintenance of the roof. In some other instance, the roofing service providers estimates an extent of the damage by the visual inspection of the series of time-lapse images of the roofs and provides an estimated cost of repairing or doing maintenance of the roof. In some embodiments, the application 120 for identifying the serviceable roofs provides a number of alerts and notifications to the roofing services providers regarding the serviceable roofs in a particular geographical area based on the time period of the weather activities that have caused the damages to the serviceable roofs. This Further, enables the roofing services providers to contact the owners of the buildings with the serviceable roofs within the stipulated timeframe of requesting for the roofing insurance claims. Thus, the roofing services providers can use the present application 120 to sell more roofing services and products to the right customers with a desired geographical area.

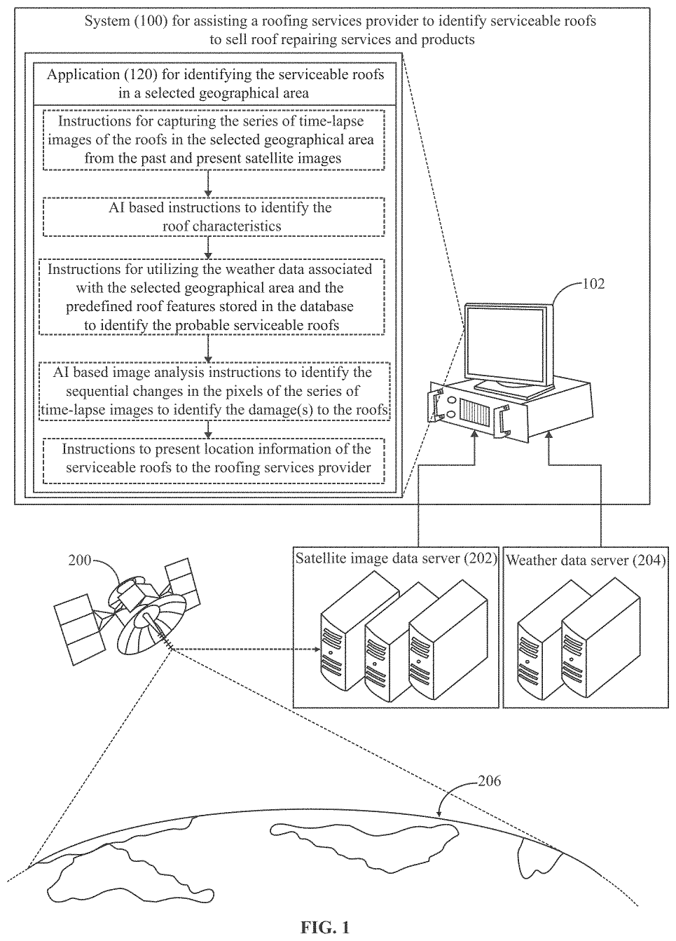

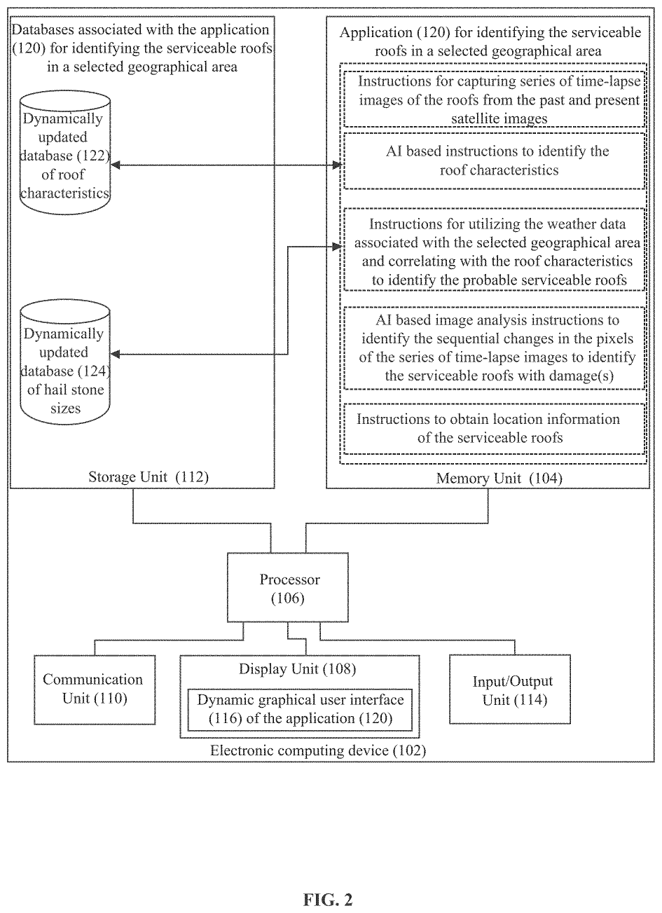

Referring now to FIG. 2, which illustrates a block diagram showing a number of hardware and software components of the electronic computing device 102 configured to run an application for identifying a number of serviceable roofs in a geographical area, according to an embodiment of the disclosed principles. According to the embodiment, the electronic computing device 102 is a computer having a memory unit 104 to store the instructions of the application 120 for identifying the serviceable roofs in a geographical area and one or more processors 106 to process the instructions of the application 120. The electronic computing device 102 further includes a display unit 108 to present the images of the roofs, which is available in form of the series of time-lapse images, through an interactive and dynamic graphical user interface 116 of the application 120 to visually identify the roof characteristics and the damages to the roofs. The electronic computing device 102 also includes a communication unit 110 to enable communication with the external network devices such as the other devices and servers over Internet through wired or wireless communication means to receive the images of the roofs of the buildings belonging to the selected geographical area. Further, the weather data associated with the particular geographical area is collected from the weather data server 204 over the Internet using the communication unit 110. A storage unit 112 associated with the electronic computing device 102 stores a variety of information associated with the application 120 for identifying the serviceable roofs in the selected geographical location(s). In some other embodiments of the disclosed principles, the storage unit 112 stores the instructions of the application 120 for identifying the serviceable roofs in the selected geographical location(s) and the instructions are made available to the memory unit 104 during execution using the processor 106. In a yet another embodiment, the storage unit 112 stores a number of information for further utilization by the application 120 during the execution of the instructions of the application 120 using the processor 106. Such information includes, but is not limited to, information related to the types and magnitude of weather activities capable of damaging the different roof types, types of hail stone sizes during a hailstorm capable of damaging the different roof types, general information related to the roof characteristics associated with different types of roofs, etc. The electronic computing device 102 also includes an input-output unit 114 to enable the device 102 to connect with peripheral devices such as, but not limited to, printers, keyboards, external display devices and other external electronic devices.

In some other embodiments, the information stored in the storage unit 112, for further utilization by the application 120, of the electronic computing device 102 is dynamically and automatically updated. In some other embodiments, the information stored in the storage unit 112, for further utilization by the application 120, is manually updated based on the visual verification of the images of the roofs obtained in form of the series of time-lapse images from the past and real-time satellite images of the selected geographical area. The visual inspection of the series of time-lapse images reveal a number of information related to each of the roofs such as, but not limited to, the roof material, past maintenance information of the roof, type of roof, age of the roof, past and present condition of the roof etc. The users visually analyzing the series of time-lapse images of the roofs are allowed to dynamically update the roof-related information stored in the storage unit 112. In some instances, the information related to the roof characteristics is stored in the storage unit 112 in form of a dynamically updated database 122. In addition, the weather data including the information related to the weather activities capable of damaging the different types of roofs are also stored in form of another dynamically updated database 124 within the storage unit 112. The present application 120 further allows the manual updating of both the database 122 and 124 by visually analyzing the images of the roofs presented through the display unit 108 and by analyzing the relevant weather information received through other sources. In a yet another embodiment, the instructions of the application 120 stored in the storage unit 112 includes artificial intelligence-based instructions to perform the automated processing and analysis of the images of the roofs, which is made available in the form of the series of time-lapse images from the past and present satellite images of the geographical area, and to identify the roof characteristics and the serviceable roofs with damages mainly caused by the severe weather activities. The artificial intelligence-based instructions of the application 120 when executed using the processor 106, enables automated updating of the dynamically updated database 122 for storing the identified roof characteristics, according to one or more embodiments of the disclosed principles. One or more features associated a variety of roofs types are stored in the database 122 and are automatically compared with the features of the roofs identified from the images of the roofs collected from the series of time-lapse images. The execution of the image processing instructions of the present application 120 using the processor 106 thus identifies the roof characteristics of each of the roofs and updates the relevant information into the dynamically updated database 122 storing the roof characteristics of different types of roofs. The artificial intelligence-based instructions of the application 120 enables the dynamic updating of the roof characteristics associated with each of the roofs into the dynamically updated database 122 and improves the speed and accuracy of automated identification of the roof characteristics associated with each of the roof types identified from the images. Similarly the artificial intelligence-based instructions of the present application 120, when executed using the processor 106, enables the automated identification of the weather activities, such as the magnitude of the hailstorm activities and sizes of the hail stones during the hailstorm activities, capable of damaging the different roof types. The artificial intelligence-based instructions of the application 120 analyzes the changes to the roofs prior to and after the severe weather activities and automatically updates the dynamically updated databases 124 of the weather activities stored in the storage unit 112 with the relevant information related to the severe weather activities capable of damaging the different roof types.

In some other embodiment of the disclosed principles, the electronic computing device 102, is a portable electronic device such as, but not limited to, a smartphone, tablet, laptop and other portable devices capable of executing the instructions of the application 120 for identifying the serviceable roofs in a selected geographical location. In some other embodiments, the electronic computing device 102 is any electronic device capable of launching the application, either installed into the device 102 or through a web interface. In such devices, the application is made available in form of a web application, or a software-as-a-service application, which can be accessed by the roofing services providers from anywhere for identifying the serviceable roofs in any selected geographical area. In all such instances, the application 120 running on the electronic computing devices 102, which can be a computer at the roofing services provider's location or a remote computer accessible to the roofing services provider, enables automated capturing of the images of the roofs in form of the series of time-lapse images obtained from the past and present satellite images of the geographical area, automated identification of the roofing characteristics of each of the roofs based on the features of the roofs stored in the dynamically updated database 122, identification of probable serviceable roofs in the images by correlating the identified roof characteristics of each of the roofs with the weather activities during the period of capturing the satellite images, identification of the serviceable roofs with severe damages by analyzing the sequential changes in the pixelated images of the roofs and the identification of the location information of each of the serviceable roofs with the damages.

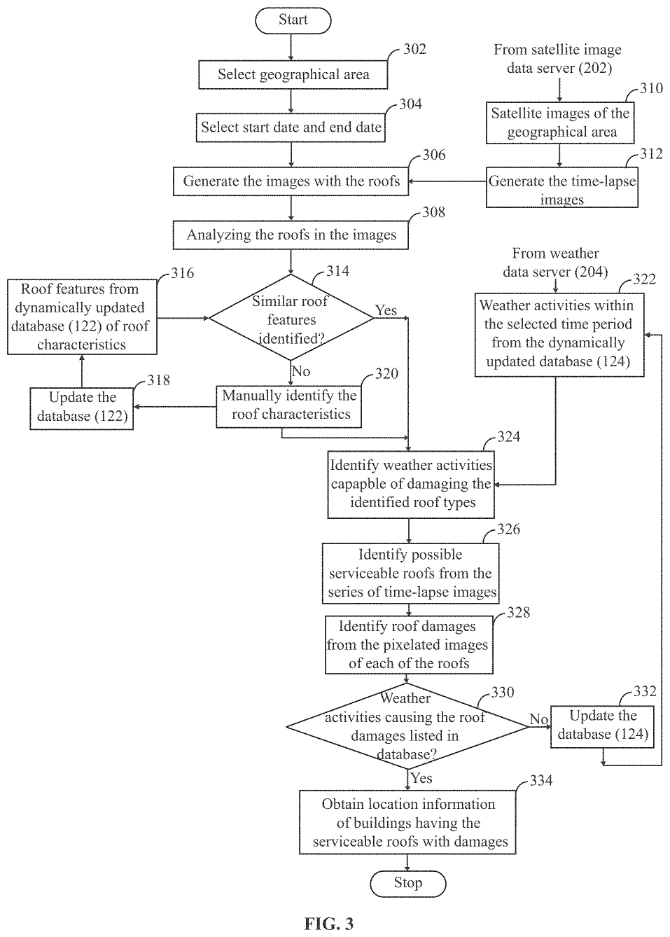

FIG. 3 illustrates a flowchart showing a number of operating steps of the present application 120 for assisting a roofing services provider to sell a number of roof repairing services and products to a number of customers, according to an embodiment of the disclosed principles. The present application 120 performs a number of steps as discussed below to identify the serviceable roofs in the selected one or more geographical locations. The roofing services providers can launch the application 120 from their electronic computing devices 102 such as a computer. The interactive dynamic graphical user interface 116 of the application 120 allows the users to set desired parameters for obtaining the details of the serviceable roofs in the desired geographical area(s). As shown in step 302, the interactive dynamic graphical user interface 116 of the application 120 allows the users to select a desired geographical area for capturing the images of the roofs for further analysis and identification of the serviceable roofs with severe damages caused by weather and other activities. In some other instances, the interactive dynamic graphical user interface 116 of the application 120 can be utilized to select multiple geographical locations and simultaneously analyze the roofs in those areas to identify the serviceable roofs with damages among them. Further, the users or the roofing services providers can select the period of time during which the changes in the roofs need to be analyzed. As in step 304, users can select a start date and an end date for obtaining the images of the roofs within the select geographical area from the satellite images of the geographical area captured within the selected period of time. The satellite images of the selected geographical area(s) are obtained from the satellite image data server 202. In some instances, the satellite image data server 202 provides the satellite images of the selected geographical area(s) through an application such as Google Earth, and other regional satellite aerial image capturing applications launched from the electronic computing device 102. In some instances, the present application 120 for identifying the serviceable roofs communicates directly with the satellite image capturing applications for capturing the images of the geographical area within the selected period of time, as in step 310. Now the series of time-lapse images of the selected geographical area is obtained from the satellite images in the step 312. In some instance, the present application 120 for identifying the serviceable roofs obtain the images of the roofs in the selected geographical area by expanding and cropping the time-lapse images obtained from the satellite images of the geographical area, captured within the selected time period.

The instructions of the present application 120 for identifying the serviceable roofs, when executed using the processor 106 of the electronic computing device 102, such as the computer provided with the roofing service provider, enables the automated analysis of each of the roofs in the images obtained in form of the time-lapse images of the roofs in the selected geographical area, which is shown in step 308. In an exemplary embodiment, the storage unit 112 of the electronic computing device 102 stores the dynamically updated database 122 of roof characteristics or roof features associated with a variety of types of roofs. The application 120 communicates with the dynamically updated database 122 of the roof characteristics to identify the types and characteristics of each of the roofs in the images as in step 316. The application 120 includes image processing instructions that identify the features, such as, but not limited to, color of the roofs, from each of the images to identify the type and the characteristics of each of the roofs in the images. As in step 314, the present application 120 identifies the similar roof features by analyzing the detected features from the images to the previously stored features from the database 122. In case the roof features are not identified from the database, the application 120 instructs the roofing services provider to manually identify the roof characteristics, as in step 320. These manually identified roof features, which are not present in the database 122 are dynamically updated by the application 120 from the user inputs related to the roof characteristics and the type of roof, which is shown in the flow diagram involving step 318.

In one or more embodiments of the disclosed principles, the image processing technique(s) performed by the processor 106, by executing the image processing instructions or the artificial intelligence-based instructions of the application, enables any suitable image detection, feature detection/extraction, pattern detection, edge detection, corner detection, blob detection, ridge detection, color detection, and/or any other image processing technique(s) to determine the roof characteristics of each of the roofs present in the series of time-lapse images obtained from the past and present satellite images of the selected geographical area(s). In some instances, the image processing instructions of the present application, when executed using the processor 106, performs a series of image processing steps, which are commonly employed to identify features from the digital image, such as, but not limited to, SIFT (Scale-Invariant Feature Transform) technique, a SURF (Speeded Up Robust Features) technique, and/or a Hough transform technique, etc., to detect the roof characteristics of each of the roofs present in the images available in form of the series of time-lapse images obtained from the past and present satellite images of the selected geographical area(s).

In some other embodiment of the disclosed principles, the image processing instructions of the present application 120, when executed using the processor 106 of the electronic computing device 102, enables identification of one or more features of the roofs and compares the identified features with the predefined or previously stored features or the roof characteristics in the dynamically updated database 122 in real-time. In some other embodiments, the image processing instructions of the application 120 include a number of artificial intelligence-based instructions configured to identify the roof characteristics, such as but not limited to, roofing material, roofing type, age of the roof, etc., by generating a matching score when comparing with the previously stored features or the roof characteristics in the dynamically updated database 122 in real-time. In a yet another embodiment, the present application 120 for identifying the serviceable roofs may incorporate a image processing and roof characteristics identification module that performs the image processing to determine which of the products or features of the roofs in the database 122 are associated with roof characteristics that “match,” or are sufficiently “similar” to, the roof characteristics of the roof determined by the present application 120. The processing steps for determining whether a particular roof characteristics in the database 122 “matches” the roof characteristic of the roofing materials present in the images may vary according to different embodiments. In some other instances, the dynamically updated database 122 storing the roofing characteristics of a variety of types of roofs may assist the application 120 to identify the roof features or the roofing characteristics of each of the roofs in the images using one or more roofing part manufacturer characteristics, such as, but not limited to, tab or tile length, recommended installation pattern, recommended exposure width, etc., associated with the roofing product. In some other instances, the dynamically updated database 122 associated with the present application may include a single database or additionally include one or more third party databases such as the respective roofing material product manufacturers.

Once the roof features of each of the roofs are identified, the present application 120 identifies the weather activities, occurred within the selected period of time, capable of damaging the identified roofs. In a certain embodiment of the disclosed principles, the weather data of the selected geographical area(s) is collected from a weather data service provider such as, but not limited to, national weather data service provider. In such an instance, the present application 120 communicates with the national weather data service provider server 204 to collect the weather data within the selected period of time. In an exemplary embodiment, the present application 120 communicates with the national oceanic and atmospheric administration servers 204 for obtaining the weather data and the received weather data map of the area within the selected period of time is overlaid on the past and present satellite images, such as, but not limited to Google Earth images, of the selected geographical area(s), captured within the same period of time. This allows the present application 120 to analyze both the images of the weather activities and the series of the time-lapse images of the roofs to identify the serviceable roofs or roofs with damages or roofs with high chances of getting damaged from the weather activities within the geographical area(s). This also enables the roofing services providers to manually identify the weather activities capable of damaging the roofs in the selected geographical area.

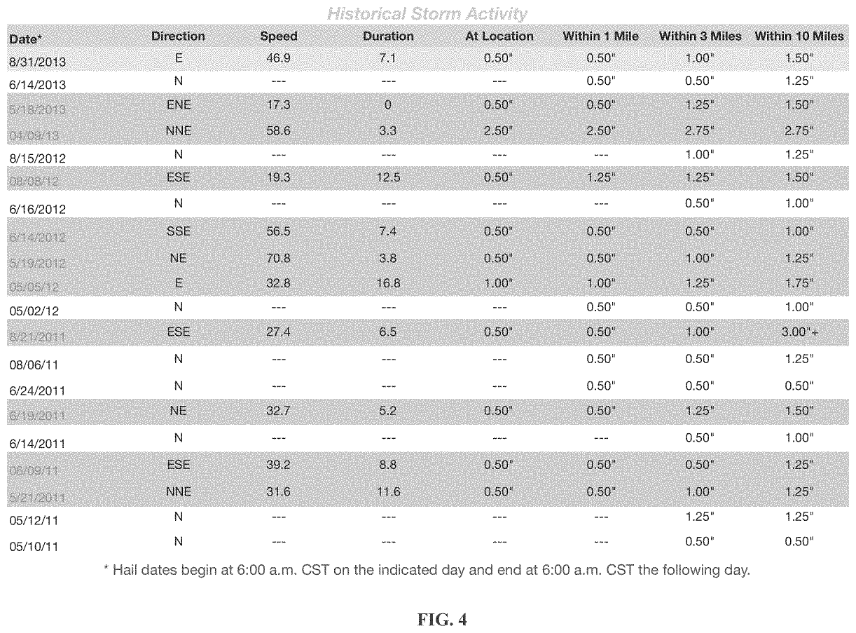

In some other instances, the weather data of any selected geographical area is collected from multiple weather data service provider servers 204 such as, but not limited to, www.interactivehailmaps.com, national oceanic and atmospheric administration (NOAA) and other weather data service providers. These weather data maps may include the detailed map of the hailstorm activities over the selected geographical area(s), which are analyzed by the present application in real-time to identify the possible serviceable roofs in the particular area. FIG. 4 is a chart showing the details of the hailstorm activities over a particular area and the hail stone sizes fell during the particular hailstorm activity, according to an exemplary embodiment of the disclosed principles. Certain weather data service providers such as the www.interactivehailmaps.com site allows the roofing services providers to select a particular geographical area, or certain address of a building within the geographical area to retrieve the past and present hailstorm activities details, within the selected time period, of the particular region and the results are presented to the application 120 for further processing to identify the roofs within the selected geographical area with high probability of getting damaged from the hailstorm activities. The hailstorm chart thus obtained from the weather data service provider servers 204 provide the dates of occurrences of the hailstorm activities at a certain building address or a selected geographical area. The weather data service provider servers 204 also provide the sizes of the hailstones, which include small hail stones that does minimal damage to the roofs, and larger hailstones of sizes 3.8 cm, which is the minimum threshold for damage to commercial roofing materials and above capable of damaging the roof materials and other A/C coils of rooftop HVAC accessories, during each of the hailstorm activities. The dates of each of the hailstorm activities can be directly obtained from the chart shown in FIG. 4, which can further be utilized to analyze the changes to the roofs in the particular geographical area prior to after the particular hailstorm activity to identify the changes to the roofs, which in turn helps to identify the serviceable and possible serviceable roofs in the particular geographical area.

Referring back to FIG. 3, the application 120 for identifying the serviceable roofs retrieves the weather data for the selected period of time as discussed in the above paragraphs from the dynamically updated database 124, as in step 322. The weather data of the selected geographical areas is correlated with the roof types or the roof characteristics of each of the roofs identified from the images to identify the possible serviceable roofs with one or more damages caused by the severe weather activities. In step 324, the weather activities occurred within the selected period of time, which is collected from the dynamically updated database 124 for the weather activities as in FIG. 4, and capable of damaging the different types of roofs identified from the images received by the application 120 are identified. This, as in step 326, leads to the shortlisting of the roofs with high chances of serviceability with damages, which are caused by the severe weather activities occurred within the selected period of time. In some instances, the artificial intelligence-based image-processing instructions of the application processes the series of time-lapse images of the roofs to identify the changes in the series of time-lapse images to identify the damages on the roofs. In some instances, the damages on the roofs is identified by comparing a number of sequential changes in one or more pixels of the series of pixelated time-lapse images, one or more changes in the roof characteristics identified from the series of time-lapse images and correlating the information thus collected with the weather activities capable of damaging the respective roof type during the time period of capture of the past and present satellite images forming the series of time-lapse images. The weather activities capable of damaging the different roofs types may vary; however, the threshold values of each weather activity for damaging each type of roof is identified from the dynamically updated database 124 of the weather activities stored in the stored in the storage unit 112 of the present electronic computing device 102 running the application 120. In some instances, the weather activities capable of damaging the different roof types include heavy rain, wind, storm, lightning, other weather related activities and hailstorm activities with hail stone sizes of 4.8 cm or more capable of damaging the different roof types. In some instance, the dynamically updated database 124 of the weather activities stored in the stored in the storage unit 112 of the present electronic computing device 102 may include the threshold sizes of the hail stones capable of damaging each types of roofs. Thus, by comparing the weather activities in the particular geographical area within the selected time period, roof characteristics of each of the roofs in the particular geographical area and the sequential changes in one or more pixels of the series of pixelated time-lapse images of each of the roofs, the application 120 can identify the serviceable roofs with damages in the particular geographical area, as in step 328.

Once the serviceable roofs with the damages are identified from the pixelated images of the roofs, which are obtained from the series of time-lapse images of the roofs captured from the past and present satellite images of the geographical area, the present application 120 identifies the location information of each of these serviceable roofs with damages and transfers the information to the roofing services provider as in step 334. The roofing services providers 334 uses the location information for making contact with the owner of the building with the serviceable roof and presents the information including the images of the damages on the roof for their verification. Further, in some instances, the roofing services provider can identify the roofing insurance provider associated with the particular building and utilize the publicly available guidelines of the roofing services provider for claiming the roofing insurance and the weather activity date, which actually damaged the roof, to assist the owner of the building to request for the roofing insurance claims to perform the relevant maintenance to the roof. In some other instances, the artificial intelligence-based instructions of the application 120 when executed using the processor 106 predicts the serviceable roofs in the geographical area and a variety of roofing maintenance related information of each of the serviceable roofs with damages. These roofing maintenance related information includes at least one type of roof maintenance required, an approximate cost of maintenance, materials required for roof maintenance, a time frame for availing the roofing insurance claims and other relevant maintenance information. This allows the roofing services providers to plan and provide better roofing products and services to the customers and helps them to properly maintain the roofs of the buildings. In some embodiments, the same weather activities affect each type of roofs differently and some may cause damages and some only contributes to the change in appearance of the roofs. In some other instance, some weather activities, rated for damaging the particular roofing type only makes small defects that are not necessarily to be treated immediately, and the artificial intelligence-based instructions of the present application automatically updates the database 124 of weather activities and threshold values of each of the weather activities capable of damaging the each roof type as in steps 330 through 332. However, in some instances, the effect of the weather activities and the threshold values of each of the weather activities obtained from the database 124 may vary depending upon a previous maintenance status, age and other previous condition of the roofs prior to the selected time period for analysis. The artificial intelligence-based instructions of the present application 120 takes into account of all these factors and automatically learns and updates the database 124 for predicting the serviceable roofs and for identifying the serviceable roofs having one or more damages with higher accuracy over time.

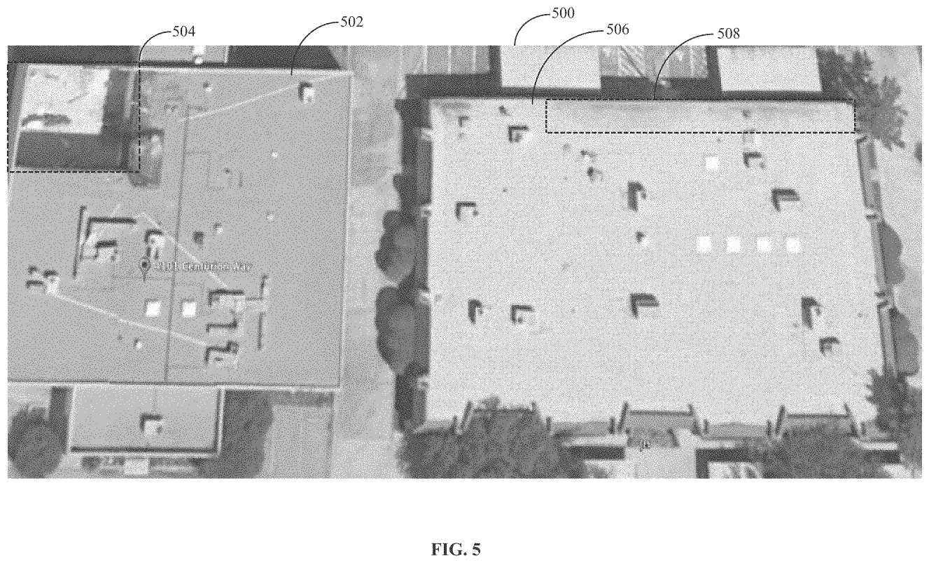

FIG. 5 is an exemplary image 500 of the roofs obtained from the series of time-lapse images captured from the past and present satellite images of the selected geographical area(s), according to an exemplary embodiment of the disclosed principles. The application 120 identifies the type of roof 502 on the left side of the image 500, which is captured on a date 1 Mar. 2011, as a ‘gravel ballasted built up roof’, from a brown color of the roof 502 and the lack of dark spots. The dark spots in the images of the roofs generally represent the presence of dirt and algae that has been left over from ponding water. The lack of dark spots on the roof 502 on the left side of the image 500 denotes the absence of dirt and algae that has been left over from ponding water commonly seen on other roof types. Further, the image processing instructions of the present application 120 is capable of differentiating the types of the roof 502 from tan colored torch down roof with the lack of seams, made by rolls of roof material forming regular, repeating seams at the joints. In some other instances, the present application 120 detects the type of roof by identifying the seams of the material covering the roof and categorizing the material based on the width of the seams. Further, the image processing instructions of the present application 120 detects a missing section or damage 504 at a top left corner, which is of different color compared to the other roof parts. The instructions of the present application identifies the missing section or damage 504 at a top left corner of the roof 502 by analyzing the image 500 captured on the above said date 1 Mar. 2011 on a series of time-lapse images captured prior to and after the above mentioned date. The present application then looks into the weather activities happened prior to the above said date and analyzes the series of time-lapse images captured prior to and after the above mentioned date to identify the type of weather activity, such as, but not limited to, a storm event or similar, responsible for the fault.

Further, the present application analyzes the roof 506 on the right side of the image 500 to identify the roof characteristics, such as the presence of dark stains along the rear edge 508 of the roof 506, which may be caused by the collection of algae and dirt near the drains. The continuous monitoring of the dark stains along the rear edge 508 of the roof 506 from the series of time-lapse images of the roof 506 helps to identify the maintenance status, replacement or roofing material and the other relevant information of the roof 506. The present application 120 allows the automated analysis and manual inspection of the roofs present in the series of time-lapse images obtained from the past and present satellite images of the geographical area(s). This in turn improves the accuracy of the present application 120 in detecting the roof characteristics and damages on the roofs. The automated inspection of the series of time-lapse images of the roofs is performed in a number of methods as discussed earlier. However, an exemplary embodiment of the present application 120 employs one or more image pixilation steps to identify the sequential changes in each pixel of the series of time-lapse images of the roofs for accurate identification of the roof characteristics and damages on the roofs. One such exemplary method for detecting the roof characteristics and damages on the roofs is discussed below.

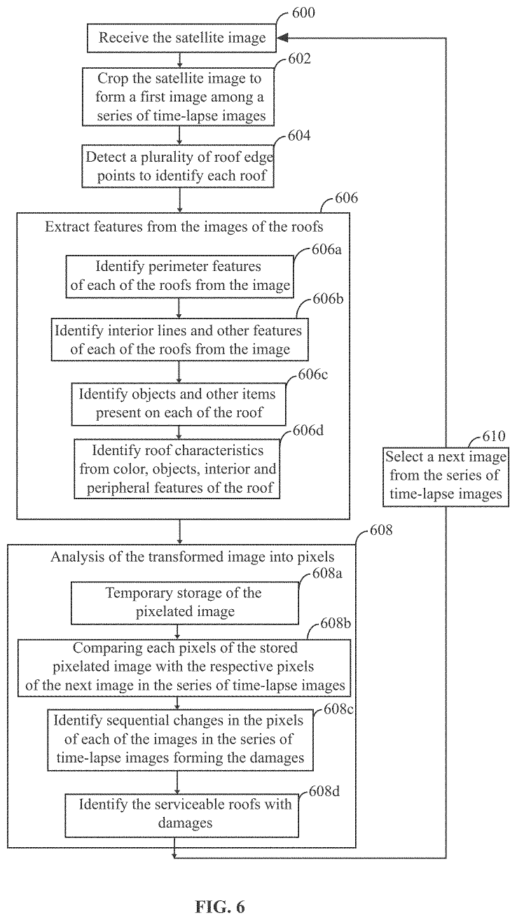

Now referring to FIG. 6 there is an exemplary flowchart showing the image processing steps for detecting the roof characteristics and damages on the roofs, according to one or more embodiments of the disclosed principles. From the first step 600, the application 120 receives the satellite image of the selected geographical area, which is captured at a specific date, such as the one captured on 1 Mar. 2011, as discussed above. Now as in step 602, the satellite image is cropped to select the desired image covering the desired number of roofs. This image forms the first image of the series of time-lapse images captured from the past and the present satellite images. Now as in step 604, the image processing instructions of the application 120 perform a variety of image processing steps to identify the edges of the roofs using an edge detection algorithm or method commonly employed in image processing application. In step 606, the image processing instructions of the present application 120 further extracts the roof features from the image in a number of steps from 606a to 606d. In some instances, the step for identifying the roof features may include the steps of identifying the perimeter features of the roof from the image as in step 606a, then identifying the interior lines and other interior features of the roof within the perimeter as in step 606b, then identification of the objects such as HVAC coils present in the roof as in step 606c and using the above information along with the color and other identified features of the roof to define the roof characteristics of each of the roofs as in step 606d. In this stage, the present application makes use of the stored roof features of a variety of roof types from the database 122 for proper identification of the roof type and other features of the roof. Now in order to detect the damages on the roof, which may be caused by the severe weather activities occurred on that geographical area, the images are transformed into pixels in step 608. In this stage, the application 120 communicates with the weather data server 204 and the stored weather activity related information capable of damaging differ types of roofs. In step 608a, the pixelated image is stored in a temporary storage for further comparison in step 608b, in which each pixel of the subsequent images in the series of time-lapse images are compared to identify the sequential changes in the pixels of each image as in step 608c. Now as in 608d, the application 120 identifies the damages on the roof by comparing the sequential changes, which happened prior to and after the sever weather activities, in the pixels of each image in the series of time-lapse images obtained from the satellite images. For example, if the same black spots exist with the addition of other black spots in the nearby pixels in the sequential images, which indicates that the same roof exists and has not been replaced and the black spots are growing or being added over time, with the increase in the age of the roof. The process is repeated until all the images in the series of time-lapse images are processed to identify the serviceable roofs with damages as in step 610.

The image processing instructions of the present application 120 may employ a variety of image processing techniques, some of which are disclosed below with the help of similar image processing techniques employed by several image processing prior art patent teachings. One such image processing technique employed in U.S. Pat. No. 7,711,157 titled “Artificial Intelligence Systems For Identifying Objects”. The process for object identification, according to the prior art, comprising extracting object shape features and object color features from digital images of an initial object and storing the extracted object shape features and object color features in a database, where said extracted object shape features and object color features are associated with a unique identifier associated with said object and repeating the first step for a plurality of different objects. Then, extracting object shape features and object color features from a digital image of an object whose identity is being sought and correlating the extracted object shape features and object color features of the object whose identity is being sought with the extracted object shape features and object color features previously stored in the database. If a first correlation of the extracted object shape features is better than a first threshold value for a given object associated with an identifier in the database and if a second correlation of the extracted object color features is better than a second threshold value for the given object, then making a determination that the object whose identity is being sought is said given object. In an embodiment, one or more steps of the above object identification utilizing object color, texture and shape features can be employed in the present application 120 for identifying the roof characteristics of the roofs and to identify one or more objects present on the roofs.

Another prior art utilizing artificial intelligence-based image-processing techniques, which can be incorporated into the image processing steps of the disclosed principles, is the U.S. Pat. No. 9,679,227 titled “System And Method For Detecting Features In Aerial Images Using Disparity Mapping And Segmentation Techniques”. The disclosed prior art system for aerial image detection and classification includes an aerial image database storing one or more aerial images electronically received from one or more image providers, and an object detection pre-processing engine in electronic communication with the aerial image database, the object detection pre-processing engine detecting and classifying objects using a disparity mapping generation sub-process to automatically process the one or more aerial images to generate a disparity map providing elevation information, a segmentation sub-process to automatically apply a pre-defined elevation threshold to the disparity map, the pre-defined elevation threshold adjustable by a user, and a classification sub-process to automatically detect and classify objects in the one or more stereoscopic pairs of aerial images by applying one or more automated detectors based on classification parameters and the pre-defined elevation threshold. One or more image analysis steps of the above prior art can be utilized by the present artificial intelligence-based image processing instructions of the present application 120 to identify the roof features from the images captured from the past and present satellite images.

Another prior art disclosing the image processing steps to identify the features from the images is disclosed in U.S. Pat. No. 5,625,710. The prior art recognizes the features such as the character from an image using pixelated form of the images to compare with a reference image to identify the changes in the pixels of the image from the reference image to identify the characters. A similar processing step can be used by the artificial intelligence-based image processing instructions of the present application 120 to identify the damages to the roofs by comparing with a previous image of the roof, before the damages, from the series of time-lapse images.

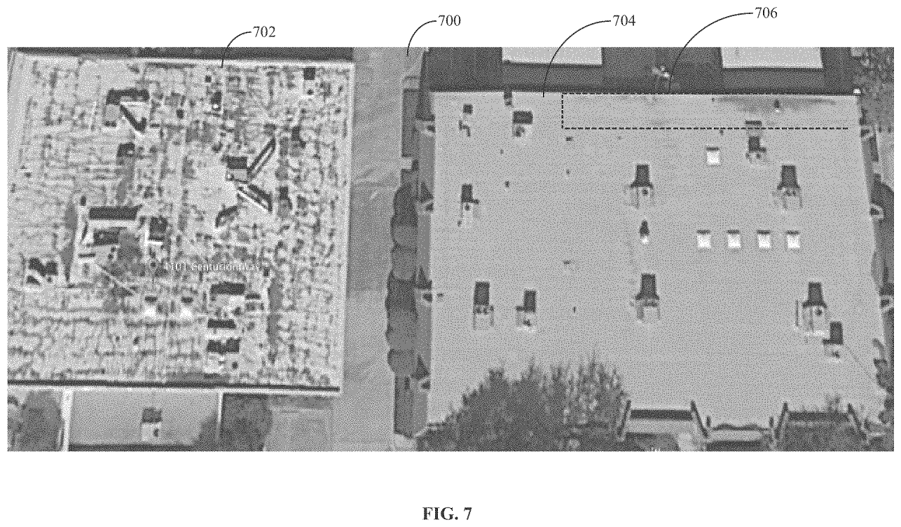

Next, referring to FIG. 7, there is an exemplary image 700 of the roofs obtained from the series of time-lapse images captured from the past and present satellite images of the selected geographical area(s), according to an exemplary embodiment of the disclosed principles. The roofs 702 and 704 in the image 700 are taken from the satellite image of the geographical area captured on Jan. 7, 2017, after 6 years from the data of capture of the image 500 in FIG. 5. From the visual analysis of the image 700 and image 500 in FIG. 5, it is clear that the top left hand square marked as 504 in FIG. 5 is repaired. Furthermore, the color and texture of the roof 702 in image 700 is changed from the roof 502 present in the image 500. This indicates the maintenance activity on the roof 502 within the six years period and the material of the roof 702 is changed from ‘gravel ballasted built up roof’ to ‘spray foam/elastomeric coated roof’. The material change on the roof 702 is identified by analyzing the pixilated image showing dark and light colors compared to the pixels of the roof 502 in the image 500. Moreover the damaged part 504 present in the roof 502 in the image 500 is also missing, pointing to a maintenance activity. The roof 704 on the right shows little growth to the dark stains along the rear edge 706, which when compared with the dark stains along the rear edge 508 of the roof 506 in FIG. 5, shows that the roof must have been repaired recently with the same material. The above information is stored in the roof characterizes of the particular roof in the geographical area and is later utilized by the present application 120 for identifying the serviceable roofs with damages caused by the severe weather activities. In some instances, the present application identifies the severe weather conditions around a particular date and analyzes the images of the roofs captured prior to and after the severe weather activities to identify the damages on the roofs caused by the weather activities such as hailstorm activity with hail stone sizes higher that a preset threshold value for the particular roof type. Table 1 and Table 2 show an exemplary threshold hailstone sizes chart for different roof types, which are utilized during the analysis of the images prior to and after the hailstorm events to easily identify the roofs with high probability of getting damaged, along with the other roof characteristics of the roofs identified from the images of the roofs.

TABLE 1
Hail threshold for low slope roof coverings

| Roof Type | Threshold Value (inches) |
|---|---|
| Built-up roofing-smooth | 1½ to 2 |
| Built-up roofing-aggregate surfaced | 2½ |
| Polymer modified bitumen membrane | 11/2 to 2 |
| Thermoplastic single ply membrane | 1 to 2 |
| EPDM | 2 |
| EPDM-ballasted | 2½ |
| Spray polyurethane foam | ¾ |
| Steel panels | 2½ |

TABLE 2
Hail stone impact test results for various roof type

| Type of | | Hailstone | Hailstone | Hailstone | Hailstone | Hailstone |
|---|---|---|---|---|---|---|
| roofing | Age | 25 mm | 32 mm | 38 mm | 44 mm | 50 mm |
| 3-tab fiber glass | 11 | 0 | 60 | 90 | 100 | 100 |
| shingles | | | | | | |
| 3-tab organic shingles | 11 | 50 | 90 | 100 | 100 | 100 |
| 30-year laminated | 11 | 0 | 0 | 60 | 90 | 100 |
| shingles | | | | | | |
| Cedar Shingles | 11 | 0 | 30 | 80 | 100 | 100 |
| Heavy Cedar shakes | 0 | 0 | 0 | 50 | 90 | 100 |
| Fiber cement tiles | 0 | 0 | 20 | 80 | 100 | 100 |
| Flat concrete tiles | 0 | 0 | 20 | 50 | 50 | 100 |
| S-shaped concrete | 0 | 0 | 0 | 0 | 0 | 80 |
| tiles | | | | | | |
| Built-up gravel | 8 | 0 | 0 | 0 | 0 | 30 |
| roofing | | | | | | |
| No. of products | | 1/9 | 5/9 | 7/9 | 7/9 | 9/9 |
| damaged | | | | | | |

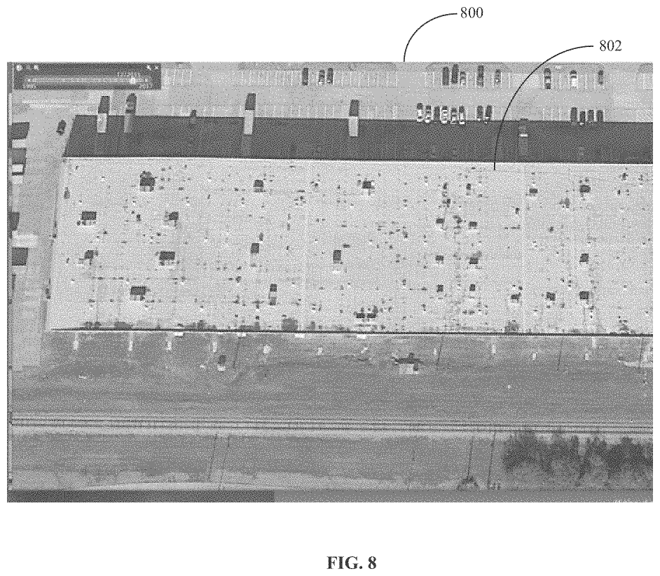

FIG. 8 to FIG. 10 shows exemplary images 800 of a roof obtained from satellite images of the selected geographical area(s) taken over a period of time from a first date 1 Dec. 2015 to a current date 1 Apr. 2018, according to an exemplary embodiment of the disclosed principles. In FIG. 8, the roof 802 in the image 800 is made up of material such as spray foam with an elastomeric coating with no signs of any damages present on the roof 802. The present application captures and processes the series of time-lapse images of the roof between the period from 1 Dec. 2015 to a current date 1 Feb. 2018 to identify the changes in the roof characteristics, including roof type, material, maintenance performed on the roof during this period, damages caused by the weather activities during this period etc.

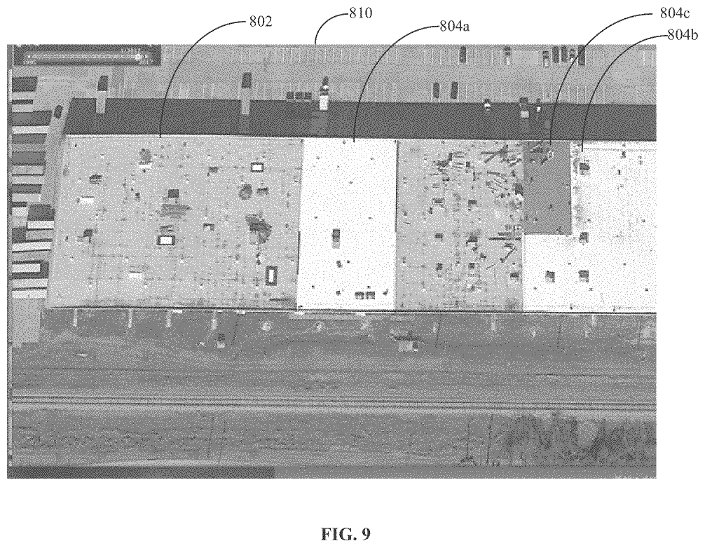

FIG. 9 is an image 810 of the roof 802 obtained from satellite images of the selected geographical area(s) taken on the date 1 Sep. 2017 within the selected period of time, i.e. within the period from 1 Dec. 2015 to the current date 1 Apr. 2018, according to an exemplary embodiment of the disclosed principles. From the analysis of FIG. 9, either visually or using the artificial intelligence-based image processing instructions of the application 120, it is clear that certain sections such as 804a to 804c of the roof 802 is modified using different materials. The present application 120 can further identify the causes of the damages that led to the maintenance at sections 804a, 804b and 804c of the roof 802 by correlating the images captured within the above time period with the weather activities that happened in the same time period covering the particular geographical area. The present application 120 can analyze the series of time-lapse images of the roof 802 captured within the above said time period and process the images to create the corresponding pixelated images. The artificial intelligence-based image processing instructions of the application 120 analyzes and compares the sequential changes in each of the pixels in the series of time-lapse images of the roof 802 and correlates with the weather information collected over the period of time to identify the damages caused on the roof 802 during this period. In a certain instance, a hailstorm activity with hail stone sizes larger than the threshold value capable of damaging the particular roof type may have fallen on the roof 802 within the above said time period, which led to the damages of the roof 802 at sections 804a, 804b and 804c of the roof 802. Furthermore, the artificial intelligence-based image processing instructions of the application 120 identifies the roofing material covering the sections 804a, 804b and 804c of the roof 802, which are different from the original roofing material of the roof 802. In some instances, the sections 804a and 804b are covered using spray polyurethane foam or thermoplastic polyolefin (TPO) sheet products and the section 804b is covered using material such as fiber cement tiles. In addition, the artificial intelligence-based image processing instructions of the application 120 identifies that the maintenance on the section 804b is performed on an earlier date than the section 804a. This is identified by the presence of dark spots on the roof section 804b, which is caused by the deposition of dirt and algae over time. The roof material at the section 804a is almost white, which lets the artificial intelligence-based image processing instructions of the application 120 to interpret a more recent maintenance activity on that part of the roof 802.

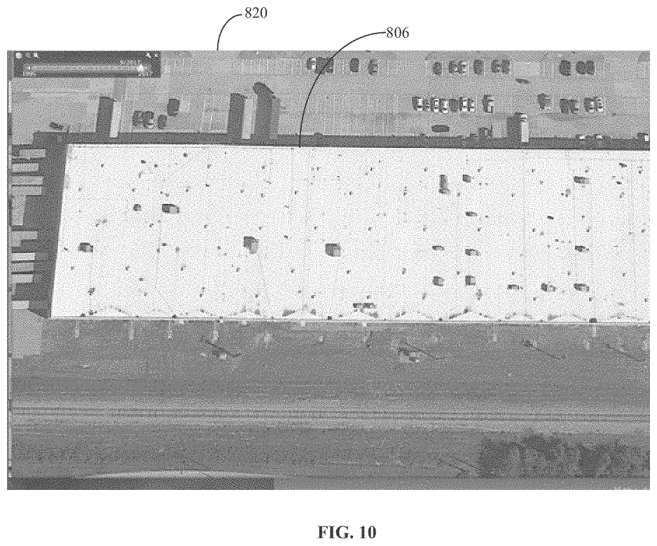

FIG. 10 is an image 820 of the roof 806 obtained from satellite images of the selected geographical area(s) taken on the current date 1 Apr. 2018, according to an exemplary embodiment of the disclosed principles. The analysis of the image 820 of the roof 806 points to the recent maintenance activity on the whole roof 806 with a single type of roof material. The present application 120 can analyze the series of time-lapse images of the roof 806 captured within the above said time period, i.e., from 1 Sep. 2017 to the current date 1 Apr. 2018, and process the images to create the corresponding pixelated images. The artificial intelligence-based image processing instructions of the application 120 analyzes and compares the sequential changes in each of the pixels in the series of time-lapse images of the roof 806 and correlates with the weather information collected over the above period of time to identify the damages caused on the roof 802 during this period. The analysis of the images might have shown the presence of damages throughout the roof 802 caused by a weather activity such as a hailstorm activity with ice size greater than the threshold value for the roof materials covering the whole roof 802. This might have led to the complete replacement or maintenance of the roofing material, as evident from the image 820. The roof 806 in the image 820 is covered with sheets of material such as, but not limited to, the spray polyurethane foam or TPO sheet products or other product that causes seams at the joints, which are visible on the roof 806 in the image 820.

Thus, the present application 120 analyzes the series of time-lapse images of the roofs and the artificial intelligence-based instructions of the application 120 continuously learns from each cycle of processing the images for providing more accurate results to the roofing services provider. In some other instances, the artificial intelligence-based instructions of the application 120 preforms automated and continuous analysis of the roofs of a particular geographical area to identify the serviceable roofs with damages and to receive real-time alerts for contacting the owners of the buildings with the serviceable roofs in time. The artificial intelligence-based instructions of the application 120 identifies the serviceable roofs by analyzing the sequential changes in the respective pixels of the series of time-lapse images and correlating with the roof characteristics and the weather activities during the series of time-lapse images capable of damaging the particular roof type. This in turn helps the owners of the building to claim their roofing insurances utilizing the visual analysis information of the roof, including images of the roof captured over a period of time, provided by the roofing services provider.

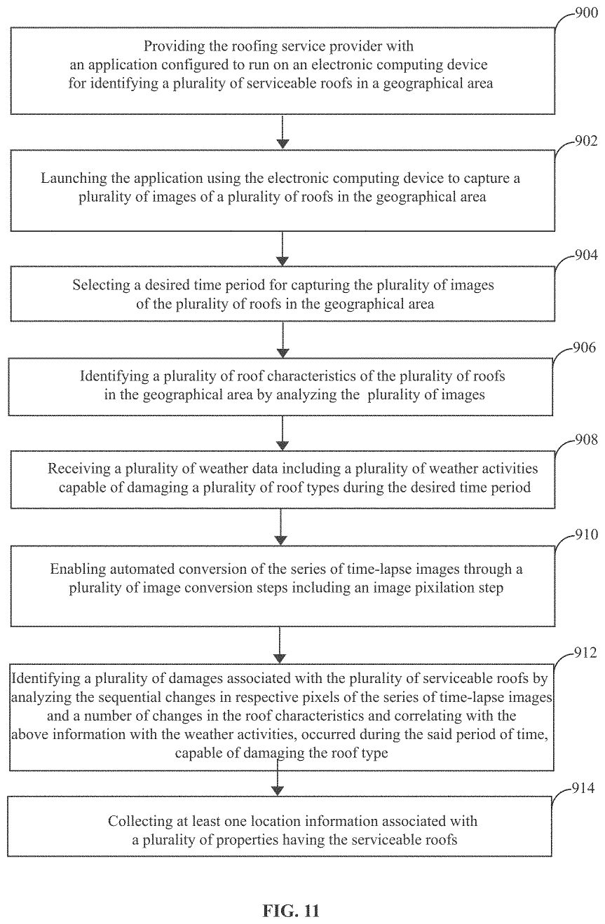

The disclosed principles further includes a computer implemented method for assisting the roofing services providers to sell a variety of roof repairing services and products to the customers, according to an exemplary embodiment of the disclosed principles. FIG. 11 is a flowchart showing the steps of the present method for assisting the roofing services providers to sell a variety of roof repairing services and products to the customers, according to an exemplary embodiment of the disclosed principles. The method includes the steps of providing the roofing service provider with the application 120 configured to run on the electronic computing device 102 for identifying the serviceable roofs in one or more selected geographical areas, as in step 900. The roofing service provider can then launch the application 120 using the electronic computing device 102 to capture the images of the roofs in the geographical area, as in step 902. Now, as in step 904, the users can select a desired time period for capturing the images of the roofs in the geographical area. The images of the roofs is obtained from a series of time-lapse images roofs obtained from the past and present satellite images covering the geographical area(s), captured within a selected time period. Now, as in block 906, the artificial intelligence-based instructions of the application 120 identifies the roof characteristics of each of the roofs in the geographical area by analyzing the images. The artificial intelligence-based instructions of the application 120 when executed using the processor 106 of the electronic computing device 102 enables identification of at least one roof type, an age of the roof, at least one roof material, at least one roof dimension, at least one roof maintenance related information, at least one pre-existing roof damage related information, at least one material covering the roof, and other related roof information. The application 120 also receives the weather data including information related to the weather activities capable of damaging the one or more roof types identified from the images during the desired time period, as in block 908. Now the artificial intelligence-based instructions of the application 120 performs automated conversion of the series of time-lapse images through a number of image conversion steps including an image pixilation step, as in block 910. The damages on the roofs is identified by analyzing the sequential changes in respective pixels of the series of time-lapse images and a number of changes in the roof characteristics and correlating with the above information with the weather activities, occurred during the said period of time, capable of damaging the roof type. As in step 912, the automated conversion of the series of time-lapse images through the image conversion steps including the image pixilation step identifies the serviceable roofs with damages. Once the serviceable roofs with damages are identified, the application 120 collects the location information associated with the properties having the serviceable roofs, as in step 914. This enables the roofing services provider to offer better services and roofing products by approaching the owners of the buildings at an appropriate time. This also enables the owners of the buildings with the serviceable roofs to approach the roofing insurance company to claim their roofing insurance for performing the maintenance on the roof caused by the severe weather activity at a certain date, the information related to which is provided by the roofing services provider. In some instances, the application 120 enables an automated and a manual analysis of the images presented in the form of the series of time-lapse images of the roofs to identify the roof characteristics. In some other instances, the present method enables the roofing services provider to predict a variety of roofing maintenance related information, such as but not limited to, at least one type of roof maintenance required, an approximate cost of maintenance, materials required for roof maintenance, a time frame for availing the roofing insurance claims and other relevant maintenance information of the roofs under monitoring.

It is noted that in the presently disclosed principles, reference is made to the roofs of buildings, however, one skilled in the art will easily understand that this method can be applied to simply inspecting the broader category of simply inspecting buildings, and not just roofs. Additionally, the present disclosure illustrates just one damaging event of concern, the impact of hail on the roofs of buildings, however, one skilled in the art will also easily understand that the disclosed principles equally apply to any type of detrimental or damaging events that involve any type of event causing damage to buildings of interest, and any type of disaster or phenomenon, such as, but not limited to any: natural disaster, manmade disaster, explosions, nuclear meltdowns, volcanoes, avalanches, land slides, weather events, hail, tornado, hurricane, typhoon, whirlwind, monsoon, cyclone, tropical storm, dam bursting, flood, fire, and earthquakes.

Further, it should be noted that the steps described in the method of use could be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, technological advances, etc., other methods of use arrangements, elimination or addition of certain steps, including or excluding certain maintenance steps, etc., may be sufficient.

The foregoing description of the exemplary embodiments of the disclosed principles have been presented for the purpose of illustration and description. While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A system for assisting at least one roofing services provider to sell a plurality of roof repairing services and products to a plurality of customers, comprising:
an electronic computing device having a memory unit configured to store a plurality of instructions of an application for identifying a plurality of serviceable roofs in a geographical area and a processor configured to execute the plurality of instructions of the application to perform a plurality of tasks including:
a) capturing a plurality of images of a plurality of roofs in the geographical area,
wherein the plurality of images of the roofs being a series of time-lapse images, obtained from a plurality of past and real-time satellite images of the geographical area, captured over a preset period of time;
b) processing the plurality of images of the roofs using a plurality of artificial intelligence (AI) based instructions to identify a plurality of roof characteristics,
wherein the plurality of roof characteristics is identified by comparing a plurality of features identified from the series of time-lapse images of the roofs with a plurality of predefined roof features associated with a plurality of roof types stored in a dynamically updated database;
c) obtaining a plurality of weather data of the geographical area over the preset period of time from at least one weather data service provider,
wherein the weather data include a plurality of weather activities including a plurality of hailstorm activities capable of damaging the plurality of roof types;
d) converting the series of time-lapse images of the roofs through a plurality of image conversion steps including an image pixilation step to identify a plurality of damages on the roofs,
wherein the plurality of damages on the roofs forming the plurality of serviceable roofs being identified by analyzing a plurality of sequential changes in a plurality of pixels of the series of time-lapse images and correlating with the roof characteristics and the plurality of weather activities during the series of time-lapse images capable of damaging the roof type; and
e) collecting at least one location information associated with a property having the serviceable roof from the plurality of past and real-time satellite images,
whereby the real-time satellite images of the geographical area presented through the real-time satellite image presentation application is captured using the application running on the electronic computing device and retrievably stores in a storage unit for processing using the processor to identify the plurality of serviceable roofs in the geographical area.

2. The system of claim 1, wherein the plurality of roof characteristics is identified by comparing the plurality of features identified from the series of time-lapse images of the roofs to the plurality predefined roof features associated with the roof types stored in the dynamically updated database;
wherein, the plurality of roof characteristics identified from the series of time-lapse images include a roof type, an age of the roof, at least one roof material, at least one roof dimension, at least one roof maintenance related information, at least one pre-existing roof damage related information, at least one material covering the roof, and other related roof information.

3. The system of claim 1, wherein the plurality of damages on the roofs is identified by comparing the plurality of sequential changes in the plurality of pixels of the series of time-lapse images, a plurality changes in the roof characteristics from the series of time-lapse images and correlating with the weather activities capable of damaging the roof type during the series of time-lapse images;
wherein, the plurality of weather activities include the hailstorm activities, heavy rain, wind, storm, lightning and other weather related activities capable of damaging the roof type.

4. The system of claim 1, wherein the artificial intelligence-based instructions of the application when executed using the processor predicts the plurality of serviceable roofs in the geographical area and a plurality of roofing maintenance related information;
wherein, the roofing maintenance related information includes at least one type of roof maintenance required, an approximate cost of maintenance, materials required for roof maintenance, a time frame for availing the roofing insurance claims and other relevant maintenance information.

5. The system of claim 1, wherein the images are generated using multispectral imaging technology selected from the group consisting of infrared, ultra-violet and thermal imaging.

6. A computer implemented method for assisting at least one roofing services provider to sell a plurality of roof repairing services and products to a plurality of customers, comprising the steps of:
a) providing the roofing service provider with an application configured to run on an electronic computing device for identifying a plurality of serviceable roofs in a geographical area;
b) launching the application using the electronic computing device to capture a plurality of images of a plurality of roofs in the geographical area;
c) selecting a desired time period for capturing the plurality of images of the plurality of roofs in the geographical area,
wherein the plurality of images of the roofs being a series of time-lapse images, obtained from a plurality of past and real-time satellite images of the geographical area, captured over the desired time period;
d) identifying a plurality of roof characteristics of the plurality of roofs in the geographical area by analyzing the plurality of images;
e) receiving a plurality of weather data including a plurality of weather activities capable of damaging a plurality of roof types during the desired time period;
f) enabling automated conversion of the series of time-lapse images through a plurality of image conversion steps including an image pixilation step to identify a plurality of damages associated with the plurality of serviceable roofs; and
g) collecting at least one location information associated with a plurality of properties having the serviceable roofs.

7. The method of claim 6, wherein the application enables an automated and a manual analysis of the plurality of images presented in form of the series of time-lapse images of the roofs to identify the plurality of roof characteristics.

8. The method of claim 7, wherein the automated analysis of the series of time-lapse images of the roofs, captured over the desired time period, for identifying the plurality of roof characteristics is performed based on a plurality of artificial intelligence-based instructions of the application,
wherein the plurality of artificial intelligence-based instructions of the application when executed using a processor of the electronic computing device enables identification of at least one roof type, an age of the roof, at least one roof material, at least one roof dimension, at least one roof maintenance related information, at least one pre-existing roof damage related information, at least one material covering the roof, and other related roof information.

9. The method of claim 6, wherein the plurality of damages on the roofs is identified by analyzing a plurality of sequential changes in a plurality of pixels of the series of time-lapse images and a plurality of changes in the roof characteristics and correlating with the plurality of weather activities capable of damaging the roof type during the series of time-lapse images.

10. The method of claim 6, wherein the artificial intelligence-based instructions of the application when executed using the processor enables prediction of a plurality of roofing maintenance related information for the serviceable roofs;
wherein, the roofing maintenance related information includes at least one type of roof maintenance required, an approximate cost of maintenance, materials required for roof maintenance, a time frame for availing the roofing insurance claims and other relevant maintenance information.

11. The method of claim 6, wherein the location information associated with the plurality of properties having the serviceable roofs is identified from the plurality of past and real-time satellite images.

12. A system for identifying buildings that are damaged in a geographic area from a damaging event, comprising:
a) accessing a date of the damaging event;
b) accessing geographic data for identifying a geographic area where the damaging event occurred;
c) accessing visual data about buildings where the damaging event occurred; and
d) identifying an individual building that was damaged based on the visual data, geographic data.

13. The method of claim 12, wherein the damaging event is selected from a group consisting of: natural disaster, manmade disaster, explosions, nuclear meltdowns, volcanoes, avalanches, land slides, weather events, hail, tornado, hurricane, typhoon, whirlwind, monsoon, cyclone, tropical storm, dam bursting, flood, fire, and earthquakes.

14. The method of claim 12, further including accessing weather data and dates associated thereto.

15. The method of claim 12, wherein accessing the visual data involves use of global positioning systems or services that allow for identification of addresses of buildings and display of a building.

16. The method of claim 12, wherein the visual data involves visual images of roofs of buildings.

17. The method of claim 16, wherein the visual images are generated using multispectral imaging technology selected from the group consisting of infrared, ultra-violet and thermal imaging.

18. The method of claim 12, wherein accessing the visual data involves use of geographic mapping system that allows for identification of addresses of buildings.

19. The method of claim 14, wherein the weather data is at least in part derived from NOAA (National Oceanic and Atmospheric Administration) collected data.

20. The method of claim 12, wherein accessing the visual data of the buildings that were in the damaging event is examined before and after the date of the damaging event.
